(19) United States
(12) Patent Application Publication
(10) Pub. No.: US 2023/0385808 A1
(43) Pub. Date: Nov. 30, 2023

(54) METHOD OF SECURING STABILITY IN VALUE OF A DIGITAL ASSET

(71) Applicant: August Consulting, Inc., Lewes, DE (US)

(72) Inventors: Phillip Berlin, Cedar Park, TX (US); Robert Fish, Irvine, CA (US)

(21) Appl. No.: 17/827,557

(22) Filed: May 27, 2022

(51) Int. Cl. G06Q 20/36; G06Q 20/38; G06Q 20/42; H04L 9/00; G06Q 20/12; G06Q 40/04

(52) U.S. Cl. CPC G06Q 20/367; G06Q 20/382; G06Q 20/42; H04L 9/50; G06Q 20/1235; G06Q 40/04; G06Q 2220/123; H04L 2209/56

(57) ABSTRACT

A Facilitator provides funding to a Payments Source, and props up or otherwise stabilizes the market value of a Digital Asset using a Payments Stream from the Payments Source to purchase and burn or otherwise dispose of purchased units of the Digital Asset.

### FIELD OF THE INVENTION

The field of the invention is computing systems for handling financial transactions.

### BACKGROUND

The following description includes information that may be useful in understanding the present invention. It is not an admission that any of the information provided herein is prior art or relevant to the presently claimed invention, or that any publication specifically or implicitly referenced is prior art.

A difficulty with Digital Assets is that their values can fluctuate wildly over time. There are so-called stable coins where value is tied to some other asset(s), but that stability depends on the relationship with the other asset(s).

It is also known to attempt to stabilize a value of a Digital Asset by limiting the number of instances of the asset, by establishing a total number of units of the Digital Asset that can ever exist, by limiting the speed at which new units of the Digital Asset are created/discovered (mining), and by destroying existing units of the Digital Asset (burning).

One problem with burning Digital Assets is that there needs to be a way of acquiring units of the Digital Asset to be burned. A market maker having a large number of units of the Digital Asset (relative to market conditions) might choose to burn some of its own units, but doing so is likely to have only minimal effect on the market because it does not affect the price others are paying. A market maker could also go into the market to purchase units of a Digital Asset, but doing so only repeat doing so where the market maker has sufficient funds.

Thus, there is still a need for additional methods of supporting stability in value of units of a Digital Asset.

### SUMMARY OF THE INVENTION

The inventive subject matter provides systems and methods in which a Facilitator props up or otherwise stabilizes the market value of a Digital Asset using a Payments Stream from a Payments Source.

The Facilitator can obtain some or all of the Funding Amount from any source or combination of sources. For example, the Facilitator could obtain at least some of the Funding Amount from a Third Party at least in part in exchange for multiple units of the Digital Asset. Additionally or alternatively, the Facilitator could obtain at least some of the Funding Amount from a Third Party at least in part in exchange for the Facilitator sharing portions of the Payments Stream from the Payments Source.

The Funding Amount is preferably repaid in full or in part by a given date. However, repayment of the Funding Amount can alternatively be altered by the amounts and/or schedule of the Payments Stream. In some embodiments, there is a cap on the Payments Stream, which might or might not be based upon a total amount of the Payments Stream paid to the Facilitator over a period of time.

The Payments Stream is preferably founded on a contract in which the Facilitator provides a Funding Amount to the Payments Source in exchange for the Payments Stream. The contract can have any suitable terms, including for example, basing the Payments Stream upon a percentage of a revenue or profit of the Payments Source, and is paid according to a monthly or other periodic schedule. In some embodiments, the percentage can be a decreasing function of the Payments Source's revenue or profit. For example, the Payments Stream could be 5% of the revenue or profit of the Payments Source up to $10,000 in revenue or profit, but then decrease proportionally to only 1% of the revenue or profit of the Payments Source over $20,000 in revenue or profit.

Unless the context clearly indicates otherwise, all transfers described herein, including transfers of Funding Amounts, Payments Streams, and ownership interest in units of a Digital Asset from one entity to another, should be interpreted as including direct transfer, indirect transfer, and any combination of direct and indirect transfer. For example, payment of a Funding Amount from a Facilitator to a Payments Source could involve the Facilitator's bank transferring of the Funding Amount in a fiat currency to an account of the Payments Source at the same or a different bank. As another example, payment of a Funding Amount from a Facilitator to a Payments Source could involve transfer of a digital coin from the Facilitator's wallet to a wallet of the Payments Source. As yet another example, payment of a Funding Amount from a Facilitator to a Payments Source could involve transfer of an amount of a fiat or digital coin from the Facilitator's wallet to a wallet of an entity other than the Payments Source, but on behalf of the Payments Source.

Transactions of ownership rights to units of the Digital Asset are preferably stored on a blockchain of a distributed ledger. To prop up or otherwise support the market value of the Digital Asset, the Facilitator uses at least some of the Payments Stream to purchase units of the Digital Asset from a marketplace or private source, and then burns the purchased units by having them deleted from the blockchain.

The contemplated methods described herein are thought to be especially useful in situations where the amount (e.g., number of units) of the Digital Asset are limited. The amount of the Digital Asset can be limited in total, or in any other suitable way, as for example by making available new units of the Digital Asset as a function of a miner expending computational resources.

The contemplated methods described herein are thought to be especially useful in situations where individual units of the Digital Asset are non-fungible.

It is also contemplated the Facilitator could have contracts serially or concurrently with multiple different Payments Sources.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic illustrating in general, aspects of an ecosystem of the inventive subject matter.

FIG. 2 is a flowchart of steps according to the inventive subject matter.

### DETAILED DESCRIPTION

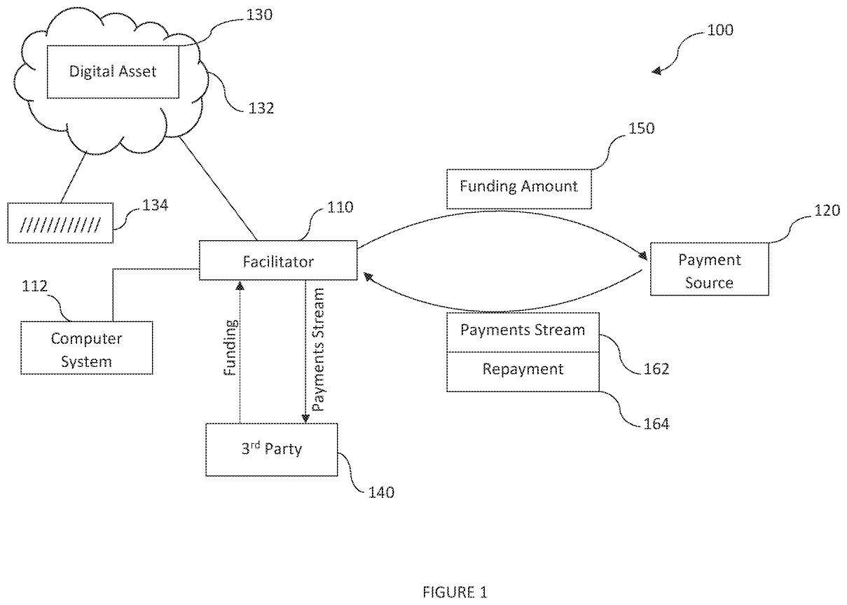

In FIG. 1, an ecosystem 100 generally includes a Facilitator 110, a Payments Source 120, a Digital Asset 130 and an optional Third Party 140. The Facilitator 110 provides a Funding Amount 150 to the Payments Source 120 in exchange for a Payments Stream 162 and a Repayment Of Principle 164.

The Facilitator 110 uses monies or other value from one or both of the Payments Stream 162 and a Repayment Of Principle 164 to purchase units of the Digital Asset 130 from the market 132 or private pool. Transactions in the Digital Asset 130 are preferably stored on a Blockchain 134, and Facilitator 110 preferably burns the purchased units of the Digital Asset by having them deleted from blockchain.

Operations of the Facilitator 110 are handled by Computer System 112.

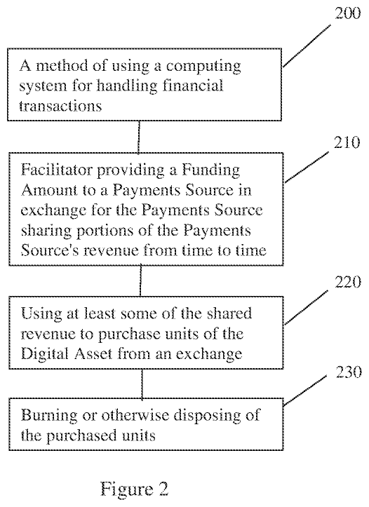

In FIG. 2 a method of using a computing system for handling financial transactions 200 generally comprises:
Step 210—A Facilitator providing a Funding Amount to a Payments Source in exchange for the Payments Source sharing portions of the Payments Source's revenue from time to time;
Step 220—Using at least some of the shared revenue to purchase units of the Digital Asset from an exchange; and
Step 230—Burning or otherwise disposing of the purchased units

As used in the description herein, and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be appreciated that all calculations contemplated herein, including calculations of index and weighted average values, can be performed by generic or special purpose servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A method of using a computing system for handling financial transactions that support stability in value of units of a Digital Asset, in which transactions of ownership of rights to the units are stored on a blockchain of a distributed ledger, the method comprising:
a Facilitator engaging in a revenue sharing agreement in which the Facilitator provides a Funding Amount to a Payments Source in exchange for the Payments Source sharing portions of the Payments Source's revenue from time to time;
making available new units of the Digital Asset as a function of a miner expending computational resources;
using at least some of the shared revenue to purchase units of the Digital Asset from an exchange; and
deleting the purchased units from the blockchain.

2. (canceled)

3. The method of claim 1, further comprising restricting a publicly available amount of the Digital Asset by limiting a total number of units of the Digital Asset that can be mined.

4. The method of claim 1, wherein individual units of the Digital Asset are non-fungible.

5. The method of claim 1, wherein the revenue sharing agreement provides that the Payments Source pay at least some of the Funding Amount by a repayment date.

6. The method of claim 1, wherein the revenue sharing agreement provides that the Payments Source pay at least some of the Funding Amount on behalf of the Facilitator rather than to the Facilitator.

7. The method of claim 1, wherein the revenue sharing agreement provides that the Funding Amount is paid to or on behalf of the Payments Source over time.

8. The method of claim 1, wherein the revenue sharing agreement provides that the sharing portions are calculated as a percentage of the Payments Source's revenue, and the percentage is a decreasing function of the Payments Source's revenue.

9. The method of claim 1, wherein the revenue sharing agreement provides for a cap on a total amount of the Payments Source's revenue that is paid to the Facilitator.

10. The method of claim 9, wherein an amount of the cap is a function of a total amount of the Payments Source sharing portions paid to the Facilitator over a period of time.

11. The method of claim 1, wherein the Facilitator obtains at least some of the Funding Amount from a Third Party at least in part in exchange for multiple units of the Digital Asset.

12. The method of claim 1, wherein the Facilitator obtains at least some of the Funding Amount from a Third Party at least in part in exchange for the Facilitator sharing portions of the Payments Stream.

13. The method of claim 1, wherein the Facilitator provides at least some of the Funding Amount to the Payments Source as multiple units of the Digital Asset.

14. A system for supporting stability in value of units of a Digital Asset, in which transactions of ownership of rights to the units are stored on a blockchain of a distributed ledger, the system comprising a computer system that execute code to record transactions in which (a) a Facilitator engages in a revenue sharing agreement in which the Facilitator provides a Funding Amount to a Payments Source in exchange for the Payments Source sharing portions of the Payments Source's revenue from time to time; (b) make available new units of the Digital Asset as a function of a miner expending computational resources (c) at least some of the shared revenue to purchase units of the Digital Asset from an exchange; and (d) at least some of the purchased units deleted from the blockchain.
